(19) United States
(12) Patent Application Publication
(10) Pub. No.: US 2010/0128565 A1
(43) Pub. Date: May 27, 2010

(54) WIRELESS COMMUNICATION USING CUSTOMIZED WIFI IN A SURVEY DATA ACQUISITION SYSTEM

(76) Inventor: DANIEL GOLPARIAN, Oslo (NO)

Correspondence Address: WesternGeco L.L.C.;Kevin McEnaney, 10001 Richmond Avenue, HOUSTON, TX, 77042-4299, US

(21) Appl. No.: 12/276,351

(22) Filed: Nov. 23, 2008

(51) Int. Cl. G01V 1/22

(52) U.S. Cl. 367/79

(57) ABSTRACT

A survey data acquisition system acquires survey data regarding a subterranean structure. Information is wirelessly communicated between a wireless survey receiver and a wireless concentrator. The wireless communication uses a wireless protocol based on a WiFi communications technology, where the wireless protocol employs time division multiplexing in which a larger number of time slots are assigned for uplink communication from the wireless survey receiver to the wireless concentrator than for downlink communication from the wireless concentrator to the wireless survey receiver.

### TECHNICAL FIELD

The invention relates generally to wireless communication using a customized WiFi technology in a survey data acquisition system.

### BACKGROUND

Seismic or electromagnetic (EM) surveying can be performed for identifying and characterizing subterranean elements, such as hydrocarbon reservoirs, fresh water aquifers, gas injection reservoirs, and so forth. With seismic surveying, one or more seismic sources are placed in various locations above a land surface or sea floor, with the seismic sources activated to generate seismic waves directed into the subterranean structure.

The seismic waves generated by a seismic source travel into the subterranean structure, with a portion of the seismic waves reflected back to the surface for receipt by seismic receivers (e.g. geophones, hydrophones, accelerometers, etc.). These seismic receivers produce signals that represent detected seismic waves. Signals from the seismic receivers are processed to yield information about the content and characteristic of the subterranean structure.

EM surveying involves deployment of one or more EM sources that produce EM waves that are propagated into the subterranean structure. EM signals are affected by elements in the subterranean structure, and the affected EM signals are detected by EM receivers, which are then processed to yield information about the content and characteristic of the subterranean structure.

In a land-based survey data acquisition system, data acquired by survey receivers is transported to a central recording station (e.g. recording truck) via a communications network. Typically, this communications network includes various types of intermediate communication units (often referred to as concentrators) connected to each other and to the receivers via cables and connectors. Deploying survey receivers using cables and connectors adds to total production costs of the land-based survey data acquisition system. Moreover, cables and connectors can lead to increased failures, and therefore, can be substantial contributors to operational downtime and operational costs. Also, cables can cause environmental damage in a survey area where the survey receivers and concentrators are deployed. To eliminate as much of the cables in the system as possible, it is desirable to send data wirelessly to a recording station, either completely or at least in some parts of the system.

### SUMMARY

In general, according to an embodiment, a network architecture of a survey data acquisition system that acquires survey data regarding a subterranean structure includes wirelessly communicating information between a wireless survey receiver and a wireless concentrator, where a semi-customized protocol based on the WiFi technology has been designed to optimize the power consumption of the wireless survey receiver.

According to another embodiment, a secondary wireless network based on the WiMAX technology connects the wireless concentrators to a central recording station.

Other or alternative features will become apparent from the following description, from the drawings, and from the claims.

### BRIEF DESCRIPTION OF THE DRAWINGS

FIG. 1 illustrates an exemplary arrangement that includes wireless survey receivers, wireless concentrators, and a central recording station, where the wireless concentrators are capable of wirelessly communicating with wireless survey receivers using a modified version of the WiFi communications protocol according to some embodiments.

FIG. 2 is a schematic diagram of an arrangement of survey receivers in which exemplary layout dimensions are provided.

FIG. 3 illustrates a structure of a time slot for carrying data between a wireless receiver and a wireless concentrator, according to an embodiment.

FIG. 4 illustrates frames each having time slot sets used for wireless communication between wireless survey receivers and wireless concentrators, according to an embodiment.

FIG. 5 illustrates a time division multiplexing and frequency reuse scheme, according to an embodiment.

FIG. 6 illustrates an exemplary arrangement in which primary WiFi-based cells are covered by secondary WiMAX-based cells, according to an embodiment.

FIG. 7 illustrates a survey data acquisition system that includes a cellular arrangement of wireless receivers and wireless concentrators in which WiFi communications according to an embodiment can be performed, and that includes WiMAX base stations for communicating with various concentrator cells, according to an embodiment.

FIG. 8 is a block diagram of a wireless survey receiver, according to an embodiment.

FIG. 9 is a block diagram of a wireless concentrator, according to an embodiment.

FIG. 10 is a block diagram illustrating communication between a central recording station and WiMAX base stations, according to an embodiment.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

In accordance with some embodiments, a wireless protocol is employed for wireless communication between wireless survey receivers and wireless concentrators in a survey data acquisition system that acquires survey data regarding a subterranean structure. A “survey receiver” refers to a module that has one or more sensors for sensing signals that are affected by the subterranean structure in response to a source signal from a survey source. The survey source can be an electromagnetic (EM) transmitter or a seismic source. The sensor of the survey receiver can be an EM sensor or a seismic sensor. A “concentrator” refers to a communications module that routes data between nodes of a survey data acquisition system.

In accordance with some embodiments, the wireless protocol used for wireless communication between a wireless survey receiver and a wireless concentrator is based on the WiFi (Wireless Fidelity) technology. The WiFi wireless technology is defined by one or more of the following standards: IEEE (Institute of Electrical and Electronics Engineers) 802.11, 802.11a, 802.11b, 802.11g, and/or 802.11n. The term “WiFi technology” or “WiFi standard” or “WiFi protocol” can refer to any of the wireless technologies referred to above, or to any subsequent technologies that evolve from any of the foregoing standards. As will be described in more detail, the wireless concentrator and the wireless receiver provide certain functionalities similar to the ones provided by the “access point” and the “station” components of the conventional WiFi technology.

Using survey receivers that incorporate chipsets for the WiFi protocol allows costs of the survey receivers to be kept at a reasonable level, since existing chipsets can be used with modifications made according to some embodiments for enhanced performance. The WiFi technology is a “high volume” technology in that chipsets that implement the WiFi technology are generally available at relatively low prices. The IEEE 802.11 standards provide a good basis for implementation of wireless telemetry in a survey data acquisition system, from both a system requirement point of view as well as from a cost point of view.

Selection of a wireless technology for a land-based survey system can be difficult due to the fact that requirements for such a system are different compared to requirements for data or telecommunications systems for which most of the existing wireless technologies have been designed and developed. Furthermore, although a wireless communications technology can solve many of the problems associated with cables, the wireless technology may also introduce some new challenges, including power management. In a wire-based system, power is distributed among large groups of receivers from power distribution units through wires. The power distribution units can in turn be connected to batteries or other sources of power like solar panels. In a wire-based system, hundreds of receivers can receive their power from one such power distribution unit. As a result, when batteries of the power distribution units need to be recharged, only a small number of power distribution units need to be collected for recharge.

In a wireless system, on the other hand, every survey receiver will have its own battery. In a large system including thousands of survey receivers, all these batteries will need to be recharged at some point. Furthermore, the weight of the battery adds to the total weight of the survey receivers, and if too heavy will cause slower deployment (placement and replacement). Therefore, low power consumption (which leads to longer battery life) is an important requirement for a wireless land-based surveying system.

The wireless protocol used according to some embodiments of the invention is a modified version of a standard WiFi protocol. More specifically, the wireless protocol used by some embodiments of the invention includes a medium access control (MAC) layer that is a modified version of the MAC layer of a standard WiFi protocol, customized to match the stringent power consumption requirements of a land-based survey system. The MAC layer is part of the data link layer specified by the Open Systems Interconnection (OSI) model, which is an abstract description for layered communications and network protocol design. The MAC layer provides addressing and channel access control mechanisms, among others, to enable nodes on the network to communicate.

In accordance with some embodiments, the modified MAC layer of the wireless protocol used for wireless communication between wireless survey receivers and wireless concentrators employs time division multiplexing access (TDMA) mechanism, in which wireless survey receivers communicate in pre-assigned time slots, both in the uplink direction (from wireless survey receivers to wireless concentrators) and in the downlink direction (from wireless concentrators to wireless survey receivers). TDMA allows for avoidance of contention between multiple wireless survey receivers that results in packet collisions (in which data packets from multiple wireless survey receivers that are transmitted at the same time collide).

Although a contention-based medium access mechanism can be used for wireless communications between wireless survey receivers and wireless concentrators, such a technique is not practical in the context of a survey data acquisition system. Since a wireless concentrator will typically have a relatively large coverage radius (e.g. 100 meters), using the traditional CSMA/CA (carrier sense multiple access/collision avoidance) mechanism of the WiFi technology it is likely that wireless survey receivers will not be able to hear each other's transmissions such that the possibility of multiple wireless survey receivers transmitting at the same time is enhanced, resulting in packet collisions and increased overhead for retry transmissions. Using the TDMA technique, on the other hand, wireless survey receivers communicate only during assigned time slots. The time slots for the wireless survey receivers (stations) are assigned by the concentrator (access point). The existing WiFi standard, as it stands currently, cannot be used; as a result, in accordance with some embodiments, modifications of the WiFi standard are provided to enable an optimal solution for the survey data acquisition application.

The modified MAC layer according to some embodiments that employs the TDMA technique enables for more efficient power management of wireless survey receivers. The implemented TDMA scheme avoids retransmission of packets due to collisions. It also allows the receivers to be in a “sleep” mode (i.e. low power mode) most of the time (i.e. except during their dedicated time slots). These two features contribute to a radical reduction in power consumption compared to an alternative implementation based on the conventional WiFi technology. The wireless survey receivers are powered by batteries, which are provided in the wireless survey receivers. Low power consumption is desirable to achieve longer battery life in the wireless survey receivers such that the wireless survey receivers can remain in the field for a longer period of time. Low power consumption (and therefore long battery life) is the key challenge in designing a survey data acquisition system that has thousands of survey receivers where each survey receiver has its own battery.

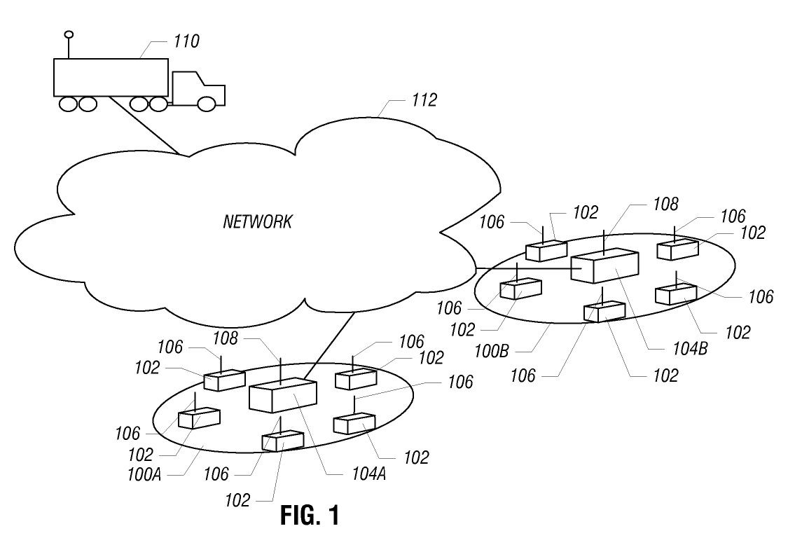

FIG. 1 illustrates an exemplary arrangement that includes wireless survey receivers 102 that are able to communicate wirelessly with wireless concentrators 104A and 104B in a cellular arrangement. The wireless receivers 102 each includes an antenna 106 for communicating wirelessly with a corresponding antenna 108 of the wireless concentrator 104A or 104B.

Each of the wireless concentrators 104A and 104B has a respective coverage area 100A and 100B in a cellular arrangement. The “coverage area” (also referred to as a “cell”) of a wireless concentrator refers to a geographic region in which the wireless concentrator is able to communicate wirelessly with a wireless survey receiver.

As noted above, the wireless communication between wireless survey receivers 102 and respective wireless concentrators 104A, 104B is according to a customized wireless protocol that is based on the WiFi technology. As depicted, in addition to the WiFi-based cellular network, another communications network 112 is provided to relay data between the survey receivers and the central recording station 110. The communications network 112 can be implemented as a wired network, a wireless network, or a combination of a wired and wireless network (a hybrid network). A specific implementation of the communications network 112 is described further below.

An example of the recording station 110 is a recording truck. The recording station 110 receives measurement data from the wireless survey receivers 102 through the wireless concentrators 104A, 104B, and through the communications network 112. The recording station 110 includes a storage subsystem to store the received measurement data. The recording station 110 is also responsible for management of the survey receivers and concentrators, as well as the network. The field crew working in the recording station can initiate shots, monitor the spread, and initiate tests and cause control messages to be sent to the survey receivers and concentrators. The recording station can also include modules that control the spread and the communications network automatically, without any human intervention.

By employing wireless communication between wireless survey receivers 102 and wireless concentrators 104A, 104B, cables do not have to be provided between the wireless survey receivers and wireless concentrators. Since a survey data acquisition system can include thousands of wireless survey receivers, even the elimination of cables only between wireless survey receivers and wireless concentrators (while implementing the network 112 with cables) can provide a significant reduction of the total amount of cables. In a typical exemplary survey data acquisition system, greater than 70% of the cables in the system are the ones that connect the receivers to the first level of concentrators. Eliminating a large number of cables can reduce production costs, as well as reduce likelihood of failures due to cable failure.

Although two wireless concentrators and respective coverage areas are depicted in FIG. 1, it is noted that a survey data acquisition system can include more than two wireless concentrators and respective coverage areas. As mentioned above, note that each coverage area 100A, 100B can also be referred to as a “cell.” Thus, in accordance with some embodiments, a cellular arrangement for wireless communications is provided, where the wireless survey receivers communicate in respective cells with a corresponding wireless concentrator.

The survey data acquisition system depicted in FIG. 1 is a real-time survey data acquisition system, in which survey data acquired by the survey receivers 102 are communicated through the concentrators for receipt by the recording station 110 on a real-time basis. A “real-time” survey data acquisition system refers to a survey data acquisition system in which data is communicated from survey receivers, either directly or indirectly through one or more concentrators, to the recording station 110 within acceptable delay limits. An “acceptable delay limit” refers to a delay in communication of survey data from a survey receiver to a recording station (directly or indirectly) within an amount of time in which an operator is able to determine whether or not the particular “shot” (activation of a survey source such as a seismic source of EM source) has resulted in the acquisition of data that is acceptable (that meets one or more predefined criteria of the operator). In other words, the delay is short enough to allow discovery of bad quality data (for example, due to environmental noise) in the recording station, followed by relatively quick initiation of a new shot (activation of a survey source for a predefined period of time and recording of the measurement data from the survey receivers during that period). Due to logistics involved in land-based survey operations, relocating survey sources and repeating shots is time consuming and adds to the total cost of operation.

A real-time survey data acquisition system is superior to a system in which data is recorded in non-volatile memory in each survey receiver and then later is retrieved. With this latter system (often referred to as autonomous system), there is no way to discover bad-quality data until the data is retrieved from the receivers at the camp. This means that to re-shoot the shots, all the receivers and sources would have to be brought back to their original locations to repeat new shots, which is extremely costly.

For the survey data acquisition system to operate in wireless mode, communications between the wireless concentrators and the recording station over the communications network 112 should also support real-time communications. As discussed further below, the WiMAX technology can be employed to implement the backhaul connection between the wireless concentrators and the recording station 110. WiMAX is one possible technology that can support real-time communications.

As noted above, the MAC layer of the customized wireless protocol is designed by modifying the MAC layer of the standard WiFi protocol. The MAC layer is implemented as firmware stored in a non-volatile memory of WiFi chipsets. The MAC layer can be modified by modifying the firmware in the chipset. Modifying the firmware is accomplished by reprogramming the non-volatile memory inside the chipset. The remaining layers of the WiFi protocol can remain unchanged.

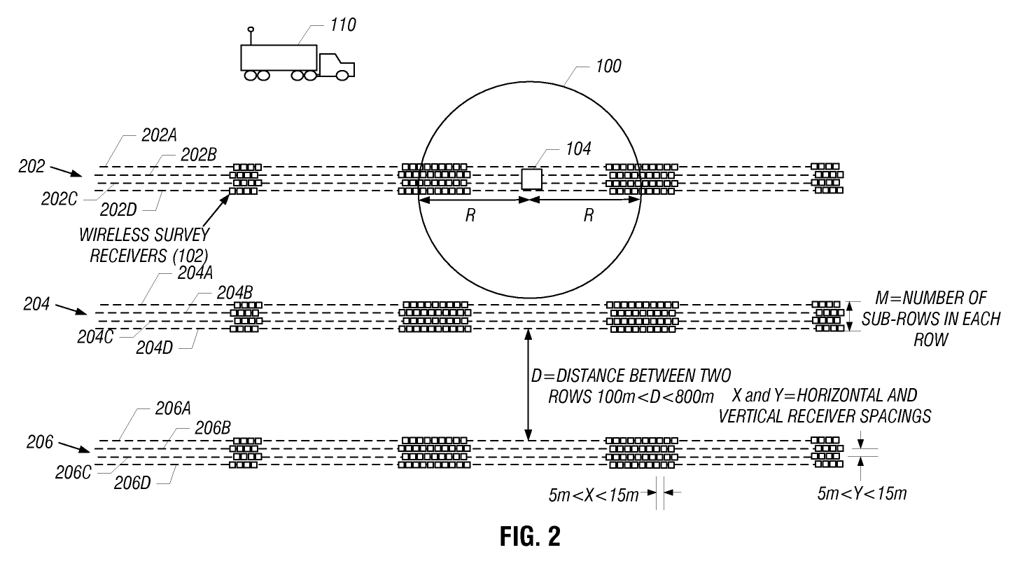

FIG. 2 shows an exemplary arrangement of survey receivers, where the arrangement includes multiple rows 202, 204, and 206 of receivers. There can be more rows of wireless survey receivers (not shown in FIG. 2). Each row of receivers includes M (e.g. 1≦M≦4) sub-rows of receivers. For example row 202 includes sub-rows 202A, 202B, 202C, and 202D; row 204 includes sub-rows 204A, 204B, 204C, and 204D; and row 206 includes sub-rows 206A, 206B, 206C, and 206D. In FIG. 2, exemplary horizontal spacings (X) and vertical spacings (Y) of receivers are also provided. Also, exemplary distances D between rows are provided. The arrangement of FIG. 2 is provided for purposes of example only. In other implementations, other arrangements of wireless survey receivers can be provided.

In FIG. 2, the survey receivers are represented as small square boxes. FIG. 2 also shows a wireless concentrator 104 (larger box) that has a coverage area 100. The radius of coverage is represented as R in FIG. 2, where R can be 100 meters or some other value. Other wireless concentrators (not shown) are also provided in the arrangement of FIG. 2 to provide coverage in other coverage areas 100.

In one exemplary dense arrangement, with an exemplary cell radius of 100 meters, each concentrator can be associated with 160 survey receivers (80 survey receivers on each side). To provide such dense arrangement, the following dimensions are employed: minimum receiver spacing (5 m), and maximum number of sub-rows (4).

In each cell (100) of the survey data acquisition system, the majority of data that has to be transmitted is the acquired survey data from the wireless survey receivers in the uplink direction (from the receivers to the concentrators to the recording station). The amount of downlink data (from the recording station or concentrators to wireless survey receivers) is much less than the amount of uplink data. Thus, the TDMA-based wireless protocol according to some embodiments allocates a larger number of time slots in the uplink direction than in the downlink direction.

In one exemplary implementation, with 2-ms sampling and 24-bit samples, 12 kbps of raw data rate is required for each uplink time slot. In other implementations, other data rates may be employed.

In addition to time slots for communicating data (referred to as data slots), time slots are also allocated for communicating other information. For example, in the downlink direction, control messages are sent to perform various tasks, such as to initiate a self test at a receiver, or to perform some other management related task. The downlink control messages can be sent to individual receivers, or to a group of receivers (multicast or broadcast).

In the downlink direction, time synchronization information is sent within the beacon slots. Each survey receiver includes a real-time clock, and the real-time clocks of the survey receivers are time-synchronized with each other. Note that acquired survey data from each receiver is time stamped with time values from the real-time clocks of the receivers. When the data is later analyzed, these time stamps are important for proper analysis of the acquired samples. The time synchronization information sent in the downlink is included in the beacons that are broadcast by the wireless concentrator to multiple wireless survey receivers to enable synchronization between real-time clocks of the receivers. Among other things, the required precision for the time synchronization determines the frequency of the beacon broadcasts.

Also in the downlink direction, other downlink control slots are assigned to communicate acknowledgment messages, such as to acknowledge receipt of survey data received in uplink slots. Such downlink control slots can also be used to communicate other messages.

In the downlink direction, a contention-based period (referred to as a “random access period”) is assigned to enable a survey receiver to start communicating in the survey data acquisition system. For example, this period can be used to communicate messages for initial system configuration. During initial deployment of a receiver, the receiver will join the network by performing a passive scan once the receiver has been powered up. The passive scan is performed by sending messages in the available random access period. Once the receiver has locked to an appropriate beacon, a channel and time slot will be negotiated with the concentrator and data communication can then begin.

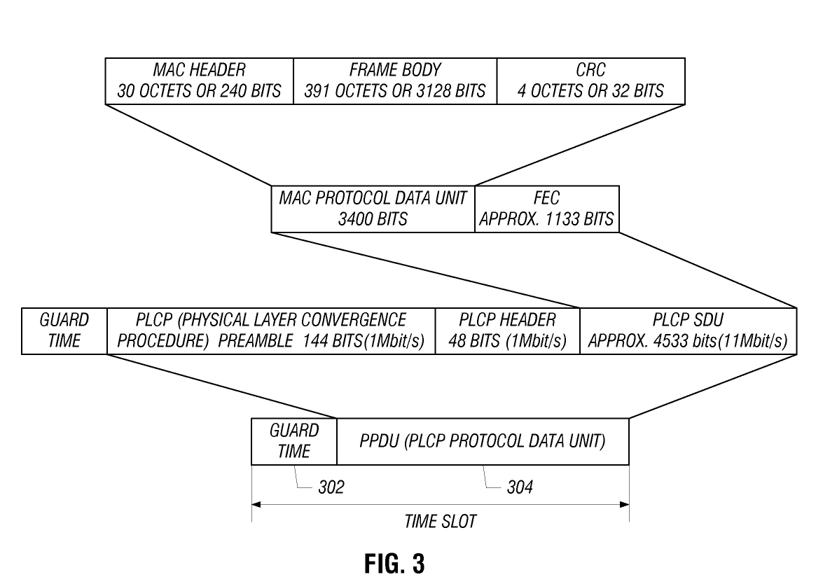

FIG. 3 shows an exemplary data structure of a particular time slot, which is consistent with the IEEE 802.11 standard. A time slot includes a guard time 302 and a PLCP (physical layer convergence procedure) protocol data unit (PPDU) 304. FIG. 3 shows a customized direct sequence PLCP used as a time slot. The PPDU 304 in turn includes a PLCP preamble, a PLCP header, and a PLCP SDU (service data unit). The SDU in turn includes a MAC protocol data unit plus a forward error correction (FEC) code for enabling error correction of the data contained in the MAC protocol data unit. The MAC protocol data unit in turn includes a MAC header, a frame body, and CRC (cyclic redundancy check) bits for detecting errors.

In the exemplary implementation shown in FIG. 3, 128 bits of overhead have been added for each 3000 bits of raw data, so the frame body includes 3128 bits. This amount of data will be repeated every 250 milliseconds (i.e. once in a frame) as an uplink channel for each wireless receiver, providing a data rate of 12.512 kbps. Such an uplink data rate satisfies the uplink requirement of the exemplary receiver implementation with 12 kbps raw data rate that was mentioned earlier. A ¾ rate FEC (forward error correction) code has been added. Taking this and the 32-bit CRC (cyclic redundancy check) code, the total length of the PLCP SDU is equal to 4533 bits. This translates to a data rate of 18.1 kbps over the air for each slot.

Other exemplary characteristics of the time slot structure are as follows:
Guard time=50 μs
PLCP Preamble=144 bits @ 1 Mbps and therefore t_{PLCP}_{_{—}}_{Preample}=144 μs
PLCP Header=48 bits @ 1 Mbps and therefore t_{PLCP}_{_{—}}_{Header}=48 μs
PLCP SDU=4533 bits @ 11 Mbps and therefore t_{PLCP}_{_{—}}_{SDU}=412 μs
Thus, Slot Length=t_{PLCP}_{_{—}}_{Guard}_{_{—}}ₜᵢₘₑ+t_{PLCP}_{_{—}}_{Preamble}+t_{PLCP}_{_{—}}_{Header}+t_{PLCP}_{_{—}}_{SDU}=654 μs

Note that in different implementations, other time slot data structures can be used.

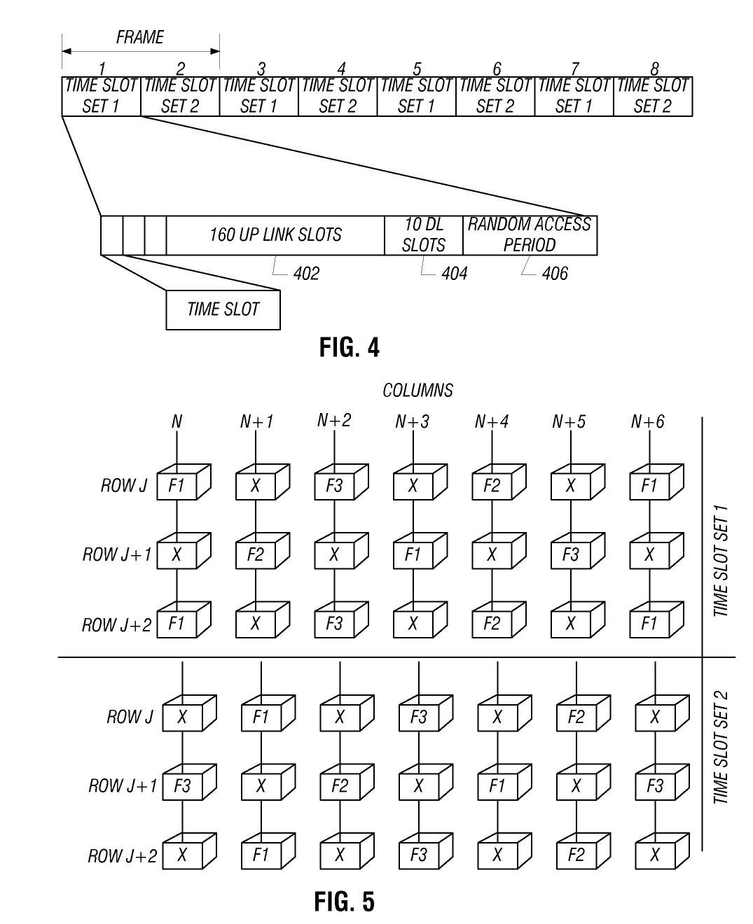

FIG. 4 shows an exemplary arrangement of time slot sets (eight time slot sets are depicted in FIG. 4). The eight time slot sets include four pairs of time slot set 1 and time slot set 2, where a pair of time slot set 1 and time slot set 2 makes up a frame having a length of 250 milliseconds. In the example of FIG. 4, each time slot set includes 160 uplink slots (402), corresponding to the 160 receivers associated with each concentrator in the densest configuration of the exemplary layout of FIG. 2, for communicating uplink data from the wireless survey receivers to the wireless concentrators, 10 downlink slots 404 for communicating acknowledgments (and other information) in the downlink from the wireless concentrators to the wireless receivers, and eight beacon slots (not shown in FIG. 4). Each time slot set also includes a contention-based random access period 406 of approximately 8 milliseconds.

The ten downlink control slots 404 are used to communicate downlink control messages as well as acknowledgment messages. To enhance the efficiency and usage of available time slots, instead of providing an individual acknowledgment of each uplink slot, an acknowledgment is provided for a group of 16 uplink slots. As a result, the ten downlink slots can provide acknowledgments for ten groups of uplink slots, where each group contains 16 uplink slots.

The random access period 406 is used by wireless survey receivers upon power up during which the wireless survey receivers perform passive scans in available random access period 406. Once a wireless survey receiver has locked to an appropriate beacon, a channel and time slot will be negotiated with the wireless concentrator and data transport can begin.

Among other things, the eight beacon slots are used to transport time synchronization information on the downlink path. The beacon slots (not shown) are equally distributed throughout the frame structure for each time slot set.

As described further below, time slot set 1 and time slot set 2 in a particular frame are not both active in a given cell. In a given cell, if time slot set 1 is used, then the cell would be inactive when time slot set 2 is used in another cell.

Two adjacent cells are covered by the same frequency but they do not use the channel simultaneously (i.e. second level of TDMA as explained further below).

In the exemplary implementation of FIG. 4, each of the time slot sets has a time length of 125 milliseconds and will include 178 slots (described above). This leaves a random access period of approximately 8 milliseconds. Of these 178 slots, 160 are uplink slots, 8 slots for beacons and 10 slots for downlink traffic. A frame has a time length of 250 milliseconds (2 time slot sets of 125 milliseconds each).

Note that the numbers of slots depicted in FIG. 4 are provided for purposes of example only, as different implementations can employ different numbers of slots.

As explained in further detail below, multiple levels of time-division multiplexing are provided. The first level of time-division multiplexing is accomplished based on allocation of time slots for uplink and downlink communications, as discussed above. In addition, time-division multiplexing is provided at the frame level, where a frame includes multiple sets of time slots, where each set includes one or more time slots. FIG. 5 shows an example of the frame-level time-division multiplexing used according to an exemplary embodiment. In this embodiment, it is assumed that there are three carrier frequencies F1-F3, and there are two time slot sets (time slot set 1 and time slot set 2, which make up a frame). A carrier frequency refers to the frequency of a wireless carrier used to carry information between a wireless survey receiver and a wireless concentrator. In different exemplary implementations, it is noted that there can be more carrier frequencies, such as twelve carrier frequencies, and other numbers of time slot sets per frame.

FIG. 5 shows three rows of wireless survey receivers (row J, row J+1, and row J+2) repeated twice for corresponding two time slot sets. Columns N, N+1, N+2, N+3, N+4, N+5, and N+6 are also depicted. The intersection of each row and each column is depicted as a cube, which represents a corresponding wireless concentrator (that provides wireless communication in a respective cell). Thus, for example, in the example of FIG. 5, the wireless concentrator at the intersection of row J and column N uses carrier frequency F1 in time slot set 1; however, in time slot set 2, this same wireless concentrator deactivates carrier frequency F1 (where deactivation is represented as an “X”). Similarly, the concentrator at the intersection of row J+1 and column N+2 does not employ carrier frequency F2 in time slot set 1, but does activate carrier frequency F2 in time slot set 2. This pattern is repeated for the other carrier frequency F3.

Effectively, the frame-level time-division multiplexing alternately activates and deactivates a particular carrier frequency, for a particular wireless concentrator (cell), in different time slot sets. For example, when a particular frequency F1 is active in a particular cell in a first time slot set, then this frequency F1 will be inactive in a second time slot set. Providing a time-based reuse of the frequencies allows for reduced co-channel interference (in which the same frequency in one cell interferes with the same frequency in a nearby cell).

The above has described the use of a modified version of WiFi for wireless communication between wireless survey receivers and wireless concentrators. In accordance with some embodiments, an additional layer of connectivity is added to the WiFi layer to implement the survey data acquisition system. In some implementations, the additional layer is according to the WiMAX (Worldwide Interoperability for Microwave Access) technology, as defined by IEEE 802.16. WiMAX is a communications technology that provides for wireless transmission of data in a variety of ways, ranging from point-to-point links to full mobile cellular-type access. WiMAX allows for efficient bandwidth use, interference avoidance, and is intended to allow higher data rates over longer distances. These features make WiMAX a good candidate for implementation of the backhaul connection that connects the wireless concentrators to the recording station in the survey data acquisition system.

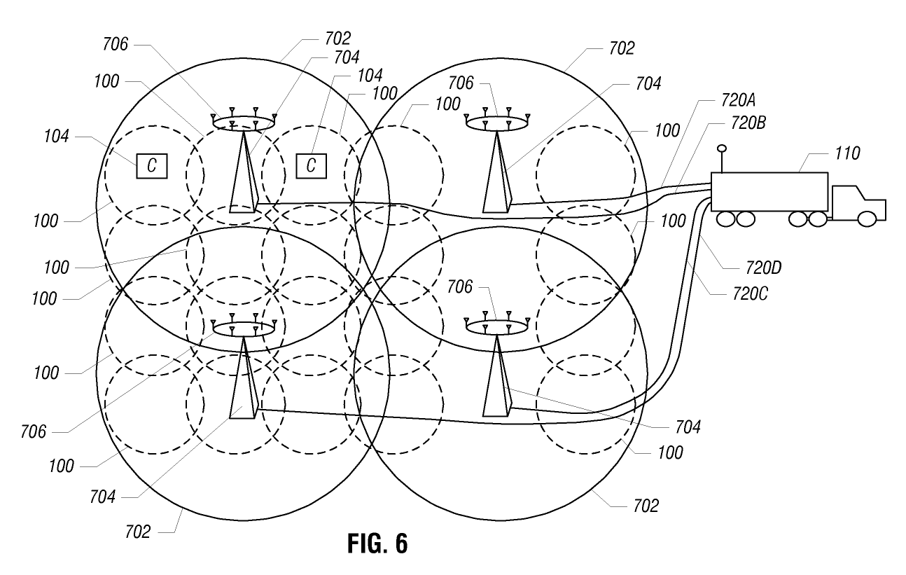

FIG. 6 shows a secondary cell-based architecture that is built upon the primary cell-based architecture using WiFi. As shown in FIG. 6, cells 100 are provided, where each cell 100 is the coverage area of a respective wireless concentrator 104 (denoted “C” in FIG. 6). The cells 100 are referred to as WiFi cells, which are part of the primary cell-based architecture.

The secondary cell-based architecture includes WiMAX cells 702, which include the coverage areas of respective WiMAX base stations 704. Thus, each WiMAX base station 704 is able to communicate with wireless concentrators 104 in the respective WiMAX cell 702. The WiMAX base station 704 includes a sectorized antenna structure 706 for performing the wireless communications with the wireless concentrators 104.

The WiMAX base stations 704 are in turn connected to the central recording station 110. In the example of FIG. 6, the connections between the WiMAX base station 704 and the recording station 110 are wired connections 720A, 720B, 720C, and 720D. Alternatively, the WiMAX base stations 704 can communicate wirelessly with the recording station 110.

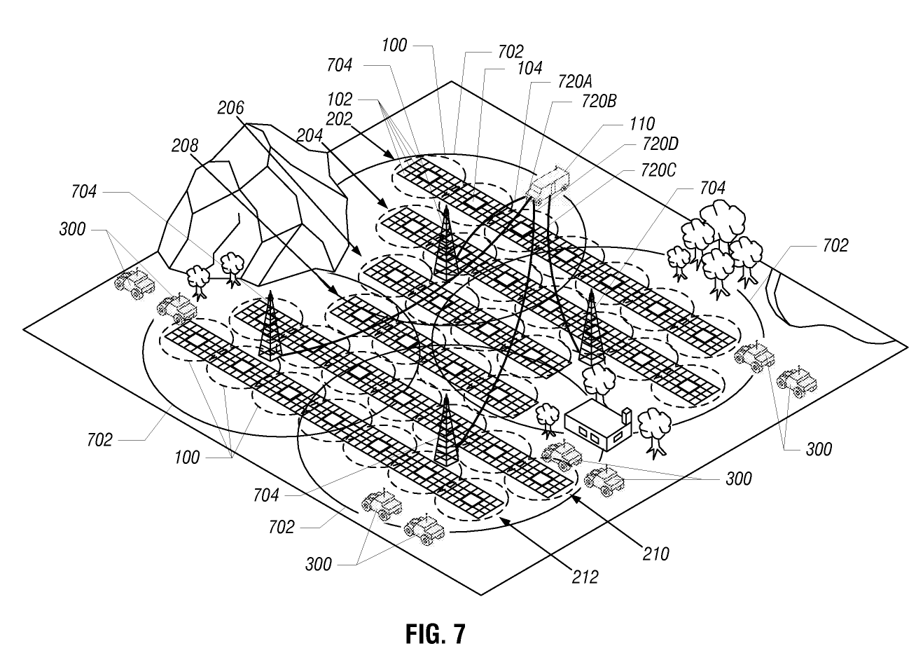

FIG. 7 is view of a survey data acquisition system, which includes multiple rows 202, 204, 206, 208, 210, and 212 of wireless survey receivers 102 and wireless concentrators 104 (the wireless survey receivers are represented by smaller boxes, whereas the wireless concentrators are represented by the larger boxes). The smaller dashed circles in FIG. 7 illustrate the coverage areas 100 of respective wireless concentrators. Also depicted in FIG. 7 are various survey sources (e.g. seismic vibrators) 300, and the recording station 110.

FIG. 7 also shows WiMAX cells 702 (larger circles) and respective WiMAX base stations 704.

As soon as wireless concentrators 104 are powered up and initialized, they start sending beacons to the wireless media. The beacons include information to advertise two consecutive periods within a time slot set, a first period including TDMA slots and a second period for random access. As described earlier, the length of these periods is predetermined and fixed.

As soon as a wireless receiver 102 wakes up, it starts scanning the wireless medium, and will eventually sense beacons from one or several wireless concentrators 104. Each wireless receiver will then report a list of the detected wireless concentrators to the recording station 110. In order to send this information to the recording station, the wireless receiver will randomly select one of the detected wireless concentrators. The recording station will eventually receive the results of the passive scans from all of the wireless receivers and run an optimization algorithm to distribute the wireless concentrators among them. The result of the optimization algorithm is then sent back to the wireless receivers. As soon as this information is received by a wireless receiver, it will start associating with the wireless concentrator that is assigned to it. The wireless receiver will use the random access period for initial association with a concentrator before dedicated time slots are assigned to it.

To conserve power, an efficient power saving mechanism has been implemented. In the mechanism, wireless receivers stay in the sleep mode most of the time, and wake up only for short periods of time corresponding to their dedicated uplink and downlink time slots. This reduces the power consumption considerably.

In the exemplary implementation of FIG. 7, the communication links 720A, 720B, 720C and 720D between the WiMAX base station 704 and the recording station 110 are implemented using fiber optic connections, such as gigabit Ethernet connections running on single-mode optical fiber. In smaller areas where the distances between the WiMAX base stations 704 and the recording station 110 can be covered by point-to-point wireless links, such as Millimetric Wireless or Free Space Optic, the wireless links can potentially replace the fiber optic connections between the WiMAX base stations and the recording station.

In the context of the 802.11 standard, a wireless concentrator and its connected wireless survey receivers can be considered a basic service set (BSS), and all the BSSs can be considered an extended service set (ESS). The concept of ESS has been retained to exchange information between BSSs. ESS allows for basic mobility in case prevailing conditions cause a wireless survey receiver at the edge of a cell to disassociate from a first wireless concentrator and re-associate with a neighboring wireless concentrator. ESS also allows basic timing and frequency re-use information to be distributed between wireless concentrators so that cell-to-cell interference can be reduced or minimized.

Again, in the context of IEEE 802.11, a distribution system entity (DSE) resides on the recording station 110 and is responsible for the communication between BSSs. The modified version of the MAC layer according to some embodiments retains the integration service, which allows communications access to other networks that are not part of the ESS. The integration service is used for connecting to the WiMAX-based backhaul connection. The customized MAC layer also supports the distribution service in order to use appropriate information to deliver or accept a message to or from another member of the ESS. The distribution service is supported by the mobility services association, re-association, and disassociation. Association allows the distribution service to know to which wireless concentrator data has to be delivered. Once connected to a concentrator, the only mobility allowed will be to a neighboring wireless concentrator, unless the wireless survey receiver is physically removed and replaced. Re-association and disassociation are also used for supporting basic mobility, since a wireless survey receiver will have to first disassociate from a first wireless concentrator before it can re-associate with a neighboring wireless concentrator.

An authentication service is also provided to prevent unauthorized access of the survey data acquisition system. De-authentication is used for terminating an existing authentication. Privacy is also supported to provide encryption to protect data communicated in the survey data acquisition system.

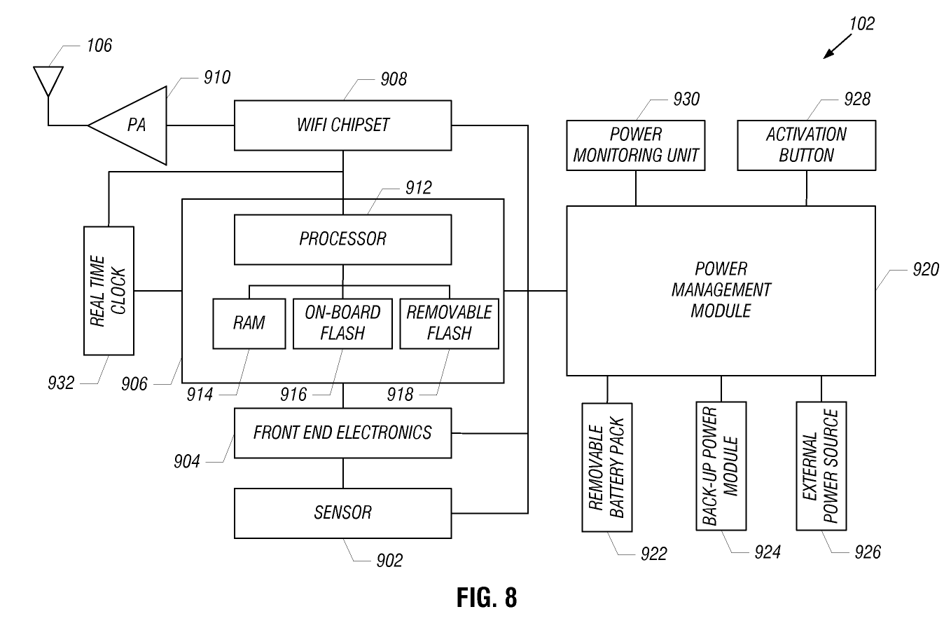

FIG. 8 is a block diagram of components within a wireless survey receiver 102, according to an embodiment. The wireless survey receiver 102 includes a sensor 902 (e.g. EM sensor or seismic sensor) that is electrically connected to front-end electronic circuitry 904 (which can include an analog-to-digital converter, signal amplifier, and/or other electronic circuitry) for processing measurement data received from the sensor 902. The measurement data processed by the front-end electronic circuitry 904 is sent to a central processing unit (CPU) 906.

The CPU 906 is in turn connected to a WiFi chipset 908, which is connected through an amplifier 910 to the antenna 106. The WiFi chipset 908 includes one or more chips to enable provision of the modified WiFi wireless protocol described above.

As further depicted in FIG. 8, the CPU 906 includes a processor 912 that may be connected to a random access memory (RAM) 914 (or other type of volatile memory), an on-board flash memory 916 (or other type of non-volatile memory), and a removable flash memory 918 (or other type of non-volatile memory). The processor 912 is able to execute software instructions to allow the wireless receiver to perform its tasks, which includes collection of measurement data. The processor 912 also provides part of the communications stack to support the modified WiFi protocol.

The wireless survey receiver 102 also includes a real-time clock 932. The real-time clock 932 provides time from which time stamps are generated for association with survey data sent on the uplink. As mentioned above, the real-time clock 932 is time synchronized with other real-time clocks in other wireless survey receivers, based on time synchronization information included in the beacons received on the downlink.

In a real-time mode of operation, the CPU 906 is able to transmit survey data through the WiFi chipset 908 for wireless communication over the antenna 106 to a wireless concentrator for delivery to the recording station 110. However, under certain scenarios, such as due to loss of wireless links (e.g. excessively high data error rates present), or failure of communications equipment, the real-time mode of operation may not be possible. In such a situation, the survey data acquisition system can operate in non-real-time mode.

In non-real-time mode, a wireless survey receiver is able to store survey data in the removable flash memory 918. The survey data stored in the removable flash memory 918 can later be retrieved and merged with the real-time data.

Alternatively, the wireless survey receiver 102 can be divided into two parts: a fixed part and a removable part. The removable part can be sent back to camp for data download, while the fixed part stays in the field. Further details regarding such a wireless survey receiver is provided in U.S. patent application Ser. No. 12/255,685, entitled “A Sensor Module Having Multiple Parts for Use in a Wireless Survey Data Acquisition System,” (Attorney Docket No. 14.0430), filed Oct. 22, 2008.

The wireless survey receiver 102 also includes a power management module 920 that receives power from one of various sources: a removable battery pack 922, a backup power module 924, and an external power source 926. The power management module 920 supplies power to the other components of the wireless survey receiver 102.

The backup power module 924 can provide power when the battery pack 922 is unavailable. The backup power module 324 can be in the form of a battery, a super-capacitor, or other energy source.

Also depicted in the example of FIG. 8 is an activation button 928 that is connected to the power management module 920. A user can actuate the activation button 928 to turn on or turn off the wireless survey receiver 102.

It is important to use the battery's limited energy in an efficient way. The activation button 928 will be typically turned on after a field crew has placed the sensors at their planed positions. Prior to the final placement of the sensor modules, the activation button 928 will be turned off to save power.

As further depicted in FIG. 8, a power monitoring unit 930 is included in the wireless survey receiver 102. The power monitoring unit 930 includes one or several mechanisms, such as LEDs (light emitting diodes) or buzzers, connected to the power management unit 930, which can indicate the status of different power sources to a field crew or to indicate other information.

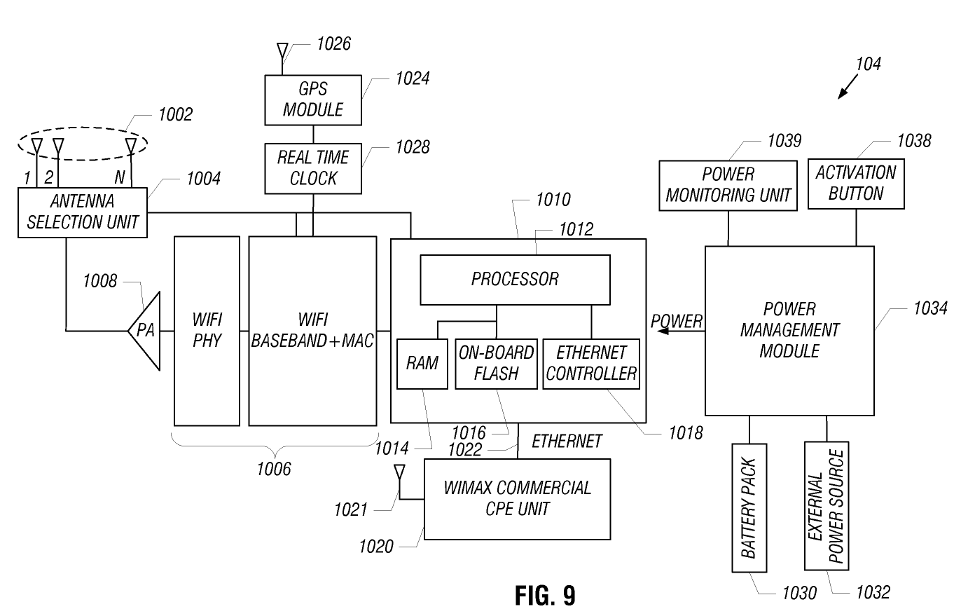

FIG. 9 shows exemplary components of a wireless concentrator 104. Each wireless concentrator 104 has a multi-element sectorized antenna system 1002, which is used for diversity gain, as well as reduction of co-channel interference with neighboring rows. An antenna selection unit 1004 is used for selecting the elements of the multi-element antenna 1002. The antenna elements are selected to achieve on optimized signal quality within the cell and to reduce the co-channel interference with the neighboring cells.

The wireless concentrator 104 also includes a WiFi chipset 1006 that includes a WiFi PHY (physical) device and a baseband plus MAC device. The baseband plus MAC device can be a commercial integrated circuit. Alternatively the baseband and the MAC functionality can be implemented in a programmable device such as a field programmable gate array (FPGA). The customized version of the WiFi MAC is implemented within this device. The baseband plus MAC device is also used to control the antenna selection unit 1004. An amplifier 1008 is provided between the WiFi chipset 1006 and the antenna selection unit 1004.

A CPU 1010 is also provided in the wireless concentrator 104, where the CPU 1010 includes a processor 1012, a random access memory 1014, a flash memory 1016, and an Ethernet controller 1018. The RAM 1014 acts as a buffer for survey data and other information that are exchanged between the wireless survey receivers and the recording station. Executable code resides in the flash memory 1016. The CPU 1010 acts as a bridge between the WiFi interface (WiFi chipset 1006) and the WiMAX interface (WiMAX CPE (customer premises equipment) unit 1020). The CPU is also responsible for performing auxiliary housekeeping functions. The flash memory 1016 can contain several MAC “profiles” (i.e. MAC firmware images). Among other things, the size and the number of the time slots within a time slot set, and the number of the time slot sets within a frame are implemented differently for each MAC profile. During the planning stage of a land survey operation, geophysical requirements as well as information about the terrain (gathered by the surveying team) are used to determine the most suitable MAC profile for the operation. The geophysical requirements such as sampling frequency and sample size are used to determine the size of the time slots. The information about the terrain is used to predict and analyze the propagation characteristics of the radio frequency signals in the area of operation. This information along with the receiver spacing requirements (that is also a part of the geophysical requirements) is used to define the radius of the cells (and therefore the number of the time slots within a time slot set). The signal propagation characteristics are also used to model the co-channel interference and determine the number of the time slot sets within a frame. Upon power up, the concentrator units will associate with a WiMAX base station and will eventually receive a command from the recoding station to download the most suitable MAC profile from the flash memory 1016 into the WiFi chipset 1006.

The WiMAX CPE unit 1020 can be a commercially available unit. The WiMAX CPE unit 1020 interfaces with the rest of the wireless concentrator through an Ethernet interface 1022, in the example depicted in FIG. 9. The WiMAX CPE unit 1020 is connected to an antenna 1021 that physically resides on the wireless concentrator unit 104. Through the antenna 1022, the WiMAX CPE unit 1020 can communicate with a WiMAX base station 704.

The wireless concentrator 110 also includes a global positioning system (GPS) module 1024 that is connected to a GPS antenna 1026. The GPS module 1024 and GPS antenna 1026 allows the wireless concentrator 110 to communicate with GPS satellites for obtaining time synchronization information from the GPS satellites. The GPS module 1024 is connected to a real-time clock (RTC) 1028, and the GPS module 1024 allows the RTC 1028 to be time synchronized to the GPS time information. The synchronized time in the RTC 1028 can in turn be used to time-synchronize RTCs in the wireless survey receivers through the WiFi interface.

The wireless concentrator 104 also includes a power management module 1034 to receive power from a battery pack 1030 and an external power source 1032. The power management module 1034 provides power to other components of the concentrator 104. The concentrator 104 also includes an activation button 1038 (for activating/deactivating the concentrator), and a power monitoring unit 1039 for providing an indication (e.g. LEDs or buzzers) of a power level in the concentrator 104.

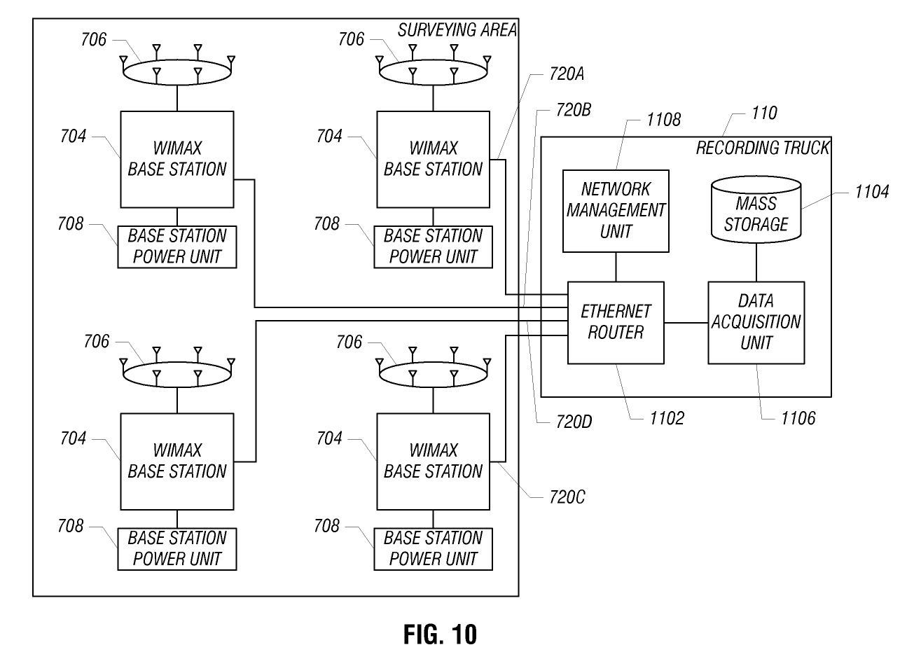

FIG. 10 shows exemplary components of the recording station 110 that is connected to a survey area including multiple WiMAX base stations 704. Each WiMAX base station 704 has a base station power unit 708 for providing power to the respective WiMAX base station. Each WiMax base station is also connected to a sectorized antenna system 706 which in turn includes several antenna elements.

The WiMAX base station 704 is connected to an Ethernet router 1102 in the recording station 110 through the communication links 720A, 720B, 720C and 720D. The communication links 720A, 720B, 720C and 720D can be implemented as wire-based links (such as fiber optic cables links) or as wireless links (such as point-to-point microwave or free space optic links). Measurement data from wireless survey receivers is sent by the WiMAX base stations 704 to the recording station 110. The data acquisition unit 1106 records the received survey data in mass storage 1104. The data acquisition unit 1106 can also perform monitoring, tests, and control functions related to the spread equipment (wireless survey receivers, concentrators, and WiMAX base stations). The monitoring, tests, and control functions initiated by the data acquisition unit 1106 can be performed automatically or with human intervention.

The recording station 110 also includes a network management unit 1108 that is responsible for the management of the network. The distribution service entity (DSE) (mentioned earlier) that is responsible for the intercommunication among the BSSs (basic service sets) is also implemented in the network management unit 1108. Among other services, the network management unit 1108 is responsible for address distribution and association and disassociation of WiFi and WiMAX equipment within the network.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A method for use with a survey data acquisition system that acquires survey data regarding a subterranean structure, comprising:
wirelessly communicating information between a wireless survey receiver and a wireless concentrator,
wherein wirelessly communicating the information comprises using a wireless protocol based on a WiFi communications technology, wherein the wireless protocol employs time division multiplexing in which a larger number of time slots are assigned for uplink communication from the wireless survey receiver to the wireless concentrator than for downlink communication from the wireless concentrator to the wireless survey receiver.

2. The method of claim 1, wherein the wireless protocol is modified from a standard WiFi protocol.

3. The method of claim 2, wherein the wireless protocol has a medium access control (MAC) layer that is modified from a MAC layer of the standard WiFi protocol.

4. The method of claim 1, further comprising wirelessly communicating information between other wireless survey receivers and other wireless concentrators using the wireless protocol,
wherein the wireless concentrators provide respective coverage areas that make up cells to enable a cellular arrangement of wireless communications between the wireless survey receivers and the wireless concentrators.

5. The method of claim 1, wherein wirelessly communicating information between the wireless survey receiver and the wireless concentrator comprises communicating survey data from the wireless survey receiver to the wireless concentrator on a real-time basis.

6. The method of claim 1, wherein wirelessly communicating information between the wireless survey receiver and the wireless concentrator comprises wirelessly communicating using a first time slot set that includes multiple time slots, where the first time slot set includes uplink slots for communicating survey data in an uplink path from the wireless survey receiver to the wireless concentrator, and downlink slots for communicating messaging from the wireless concentrator to the wireless survey receiver.

7. The method of claim 6, wherein communicating the messaging in the downlink slots comprises communicating at least one of the following: acknowledgment messaging of survey data received in the uplink slots; control messaging to cause the wireless survey receiver to perform a task; and time synchronization information to time synchronize a real-time clock in the wireless survey receiver.

8. The method of claim 6, wherein multiple time slot sets make up a frame, wherein wirelessly communicating information between the wireless survey receiver and the wireless concentrator uses at least one carrier frequency, and wherein the wireless concentrator activates the at least one carrier frequency in the first time slot set, but the wireless concentrator deactivates the at least one carrier frequency in another one of the multiple time slot sets.

9. The method of claim 1, wherein each of the wireless survey receiver and wireless concentrator includes a WiFi chipset to support the wireless protocol, the method further comprising:
reprogramming the WiFi chipset in each of the wireless survey receiver and wireless concentrator to provide a modified medium access control (MAC) layer in the WiFi chipset, wherein the modified MAC layer is modified from a standard WiFi MAC layer.

10. The method of claim 1, further comprising:
communicating backhaul information between the wireless concentrator and a recording station through a communications network that includes a cellular arrangement of base stations.

11. The method of claim 10, wherein communicating the backhaul information through the communications network that includes the cellular arrangement of base stations comprises communicating the backhaul information using WiMAX base stations.

12. The method of claim 11, further comprising:
each of the WiMAX base stations communicating wirelessly with a group of wireless concentrators; and
each of the WiMAX base stations communicating with the recording station.

13. A survey data acquisition system comprising:
wireless survey receivers to receive survey data affected by a subterranean structure; and
at least one wireless concentrator to communicate wirelessly with the wireless survey receivers using a wireless protocol that is based on a WiFi communications technology, wherein the wireless protocol employs time division multiplexing that assigns uplink time slots for uplink communication and downlink time slots for downlink communication, wherein a number of uplink time slots is greater than a number of downlink time slots.

14. The survey data acquisition system of claim 13, wherein the wireless protocol employs a medium access control (MAC) layer that is different from a WiFi MAC layer.

15. The survey data acquisition system of claim 13, further comprising:
a recording station to receive the survey data sent by the wireless survey receivers through the at least one wireless concentrator.

16. The survey data acquisition system of claim 15, further comprising:
a wireless base station that is part of a cellular network to communicate the survey data from the at least one wireless concentrator to the recording station.

17. The survey data acquisition system of claim 16, wherein the wireless base station comprises a WiMAX base station.

18. The survey data acquisition system of claim 13, wherein the wireless protocol employs a time and frequency reuse pattern.

19. A wireless survey receiver comprising:
a sensor to receive survey data affected by a subterranean structure;
a wireless interface to send the survey data wirelessly to a wireless concentrator, wherein the wireless interface employs a wireless protocol that is based on a WiFi communications technology, wherein the wireless protocol employs time division multiplexing that assigns uplink time slots for uplink communication and downlink time slots for downlink communication, wherein a number of uplink time slots is greater than a number of downlink time slots.

20. The wireless survey receiver of claim 19, wherein the sensor comprises an electromagnetic sensor and a seismic sensor.
